(19) United States
(12) Patent Application Publication
(10) Pub. No.: US 2003/0090502 A1
(43) Pub. Date: May 15, 2003

(54) Method and apparatus for indicating information

(76) Inventors: Toshiyuki Yuasa, Ibaraki (JP); Hiroshi Fujimoto, Kawasaki (JP); Kazuyuki Ikeda, Kokubunzi (JP); Kenichi Ishino, Chiba (JP); Tetsuo Tanaka, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/091,496

(22) Filed: Mar. 7, 2002

(30) Foreign Application Priority Data
Nov. 15, 2001 (JP) 2001-349563

(51) Int. Cl. G06F 7/00

(52) U.S. Cl. 345/700

(57) ABSTRACT

The present invention indicates shared data stored in a service site to an information viewer site in an indication form corresponding to customization information stored in customization information storing means which corresponds to an information transmitter site.

### BACKGROUND OF THE INVENTION

The present invention relates to the field of database management, and more particularly to a database in which information is shared among a plurality of organizations. The examples to which the present invention is applied include intercorporate information sharing apparatuses and information sharing meditation service providing methods. Particularly, the present invention pertains to an apparatus and a method for providing meditation service for information sharing between any information transmitters and information viewers.

Conventionally, a service site for mediating information sharing among enterprises provides an information sharing function as described bellow. The service site has a database in which an information publisher registers data that the publisher wants to publish by entering the data in a template screen provided by the service site. An information viewer, on the other hand, refers to the registered published data in the form of display contents embedded in the template screen.

For example, JP-A No. 2000-293300 discloses a technique for realizing a system which generates a screen based on template information registered beforehand to receive data from the user. In this technique, the template information is set for each record item of the database by specifying: whether the input field of the item must be displayed in the input screen; the display order of the input field if the input field must be displayed; and the default value for the item. When a user has requested access to the database, the template information for the user is determined based on the ID of the user, and a screen is generated based on the template information and sent to the terminal. Through the templates, it is possible to provide only items required by the user by selecting them from the record items of the database.

In the above conventional technique, if a plurality of information transmitters each use different record items for information sharing, the service site must hold such a database which supports all the different record items, or alternatively the service site must handle each information transmitter separately. For example, assume that a transmitter A wants to use record items a and b while a transmitter B wants to use record items c and d. In this case, the service site must support each of the record items a to d. This means that the database includes a redundant area since the transmitter A does not use the items c and d, and the transmitter B does not use the items a and b.

Furthermore, in the above conventional technique, it is difficult for a plurality of transmitters to share data whose record item name differs from one transmitter to another (that is, it is difficult to employ a single record item whose item name uniquely specifies the data), since each transmitter uses a different item name to indicate the data. For example, if some transmitters use the key code “product code” and other transmitters use the key code “part number” to uniquely specify the same product, the service site must support both record items (key codes) “product code” and “part number”, producing redundancy as in the above case.

### SUMMARY OF THE INVENTION

An object of the present invention is to provide a method and a system for efficiently managing information to be indicated to a plurality of persons.

Another object of the present invention is to provide a method and a system for indicating information in a form which can easily be viewed by a person who receives it.

The present invention outputs records such that the outputting manner including the viewing template is changed for each record. Further, a mode of the present invention changes the outputting manner depending on each transmitter which transmits information to a database (that is, depending on the side which transmits or stores information to be stored in a database). It should be noted that the outputting manner includes the output form. The output form includes a template of the contents of the database, and the template, in turn, includes display items, a display order, etc.

Another mode of the present invention associates an identifier (identification information) for identifying an information transmitter (provider) with customization information for defining an outputting manner, and determines the outputting manner based on this corresponding relationship (association). For example, an information transmitter transmits (stores) information to a database together with its identifier, and the database stores the identifier and the information to be stored in the database such that the identifier and the information to be stored in the database are associated with each other. Then, when a request for outputting this information is issued, the information is output in an outputting manner determined based on customization information corresponding to the associated identifier. It should be noted that the database may store the information to be stored in the database and the customization information such that the information and the customization information are associated with each other. In this case, the database searches for customization information corresponding to a transmitted identifier using the identifier as a key, and associates the retrieved customization information with the information (to be stored in the database).

It should be noted that still another mode of the present invention is configured such that an information transmitting side apparatus, an information viewing side apparatus, and a database are connected to one another through a network.

According to the present invention, it is possible to efficiently manage information to be indicated to a plurality of persons.

According to the present invention, since the indication form of information can be changed based on a request from a person who receives the indication of the information, the person can easily view the information.

According to the present invention, since information can be indicated in an indication form determined based on a request from a person who receives the information, the person can easily view the information.

### BRIEF DESCRIPTION OF THE DRAWINGS

FIG. 1 is a diagram showing the configuration of a system for realizing an intercorporate information sharing method according to the present invention;

FIG. 2 is a main flowchart according to the present invention;

FIG. 3 is a diagram showing a login screen according to the present invention;

FIG. 4 is a schematic diagram showing a data structure of a user list according to the present invention;

FIG. 5 is a diagram showing a menu screen according to the present invention;

FIG. 6 is a flowchart of a customization information generating function;

FIG. 7 is a diagram showing a display item setting screen used by the customization information generating function according to the present invention;

FIG. 8 is a diagram showing a data structure of customization information on display items according to the present invention, and example data;

FIG. 9 is a diagram showing a key item setting screen used by the customization information generating function according to the present invention;

FIG. 10 is a schematic diagram showing a data structure of customization information on key items according to the present invention;

FIG. 11 is a flowchart of a shared data uploading function according to the present invention;

FIG. 12 is a diagram showing a screen for accepting uploading of data of a shared data file according to the present invention;

FIG. 13 is a flowchart of a search function according to the present invention;

FIG. 14 is a diagram showing a screen for receiving search conditions according to the present invention; and

FIG. 15 is a diagram showing a screen for displaying search results according to the present invention.

### DETAILED DESCRIPTION OF THE PREFERRED EMBODIMENTS OF THE PRESENT INVENTION

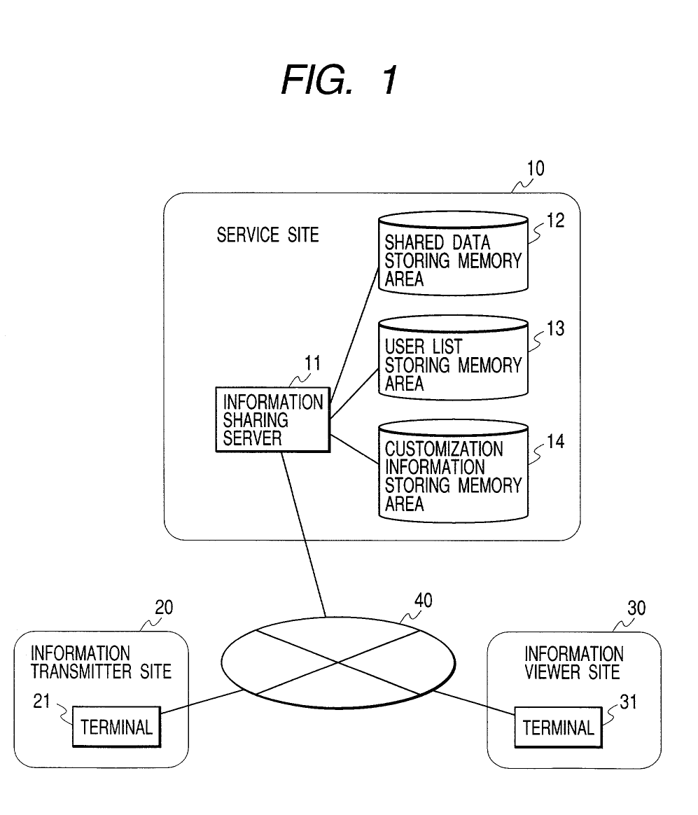

FIG. 1 is a diagram showing the configuration of an information system according to an embodiment of the present invention. In the figure, a service site 10 has an information sharing server 11 for sharing information among enterprises, and the information sharing server 11 is connected to both a terminal 21 in an information transmitter site 20 and a terminal 31 in an information viewer site 30 through a communications network 40. The communications network 40 may be the Internet or may be another communications line. Furthermore, there may be a plurality of information transmitter sites 20 and a plurality of information viewer sites 30 connected to the communications network 40.

The information sharing server 11 is a computer system, such as one including a personal computer or a server, capable of executing a program. Some computer systems include a file system. The computer system comprises a central processing unit, a storage device, and a communications device, and may further include an input device and a display device.

The terminals 21 and 31 are also computer systems such as personal computers capable of executing a program. Each computer system comprises a central processing unit, a storage device, a communications device, an input device, and a display device.

The information sharing server 11 is connected to a shared data memory area 12 and a template memory area 13. The shared data memory area 12 and the template memory area 13 are database servers each made up of a computer system on which a database management system runs and a storage device having a large capacity, such as a hard disk drive, connected to the computer system.

The information sharing server 11 provides a service function based on a request for data search, data registration, etc. issued from terminals 21 and 31. This example assumes that the WWW (World Wide Web) technology is used to provide a service function to the terminals 21 and 31 through the communications line 40. That is, it is assumed that a program realizing a WWW server function such as HTTP is running on the information sharing server 11. Furthermore, the terminals 21 and 31 each have a WWW browser, and activating the browser and following the HTTP protocol to access the information sharing server 11 displays a screen in the terminals 21 and 31 based on HTML (Hypertext Markup Language) data transmitted from the information sharing server 11.

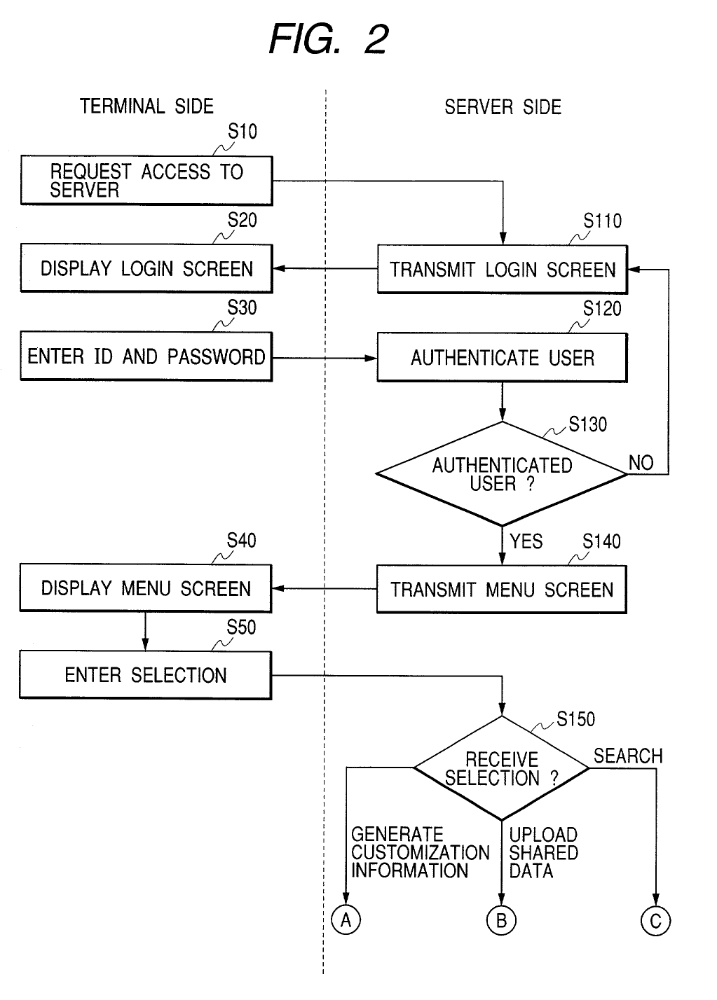

FIG. 2 shows the main processing procedure employed by the present embodiment. The processing proceeds as the terminal 21 or 31 exchanges data with the information sharing server 11. The browser carries out processing on the “terminal 21” or “terminal 31” side, while a WWW server or a CGI (Common Gateway Interface) program called by the WWW server carries out processing on the “information sharing server 11” side. It should be noted that in the following description, the term “a terminal” or “the terminal” refers to either the terminal 21 or the terminal 31.

First of all, the user activates the browser in the terminal and transmits an access request to the server side at step S10. At step S110, upon receiving the access request, the information sharing server 11 retrieves a file containing HTML data expressing a login screen prepared within the file system beforehand, and transmits it to the terminal. At step S20, the terminal displays the login screen in the browser based on the contents of the received HTML file.

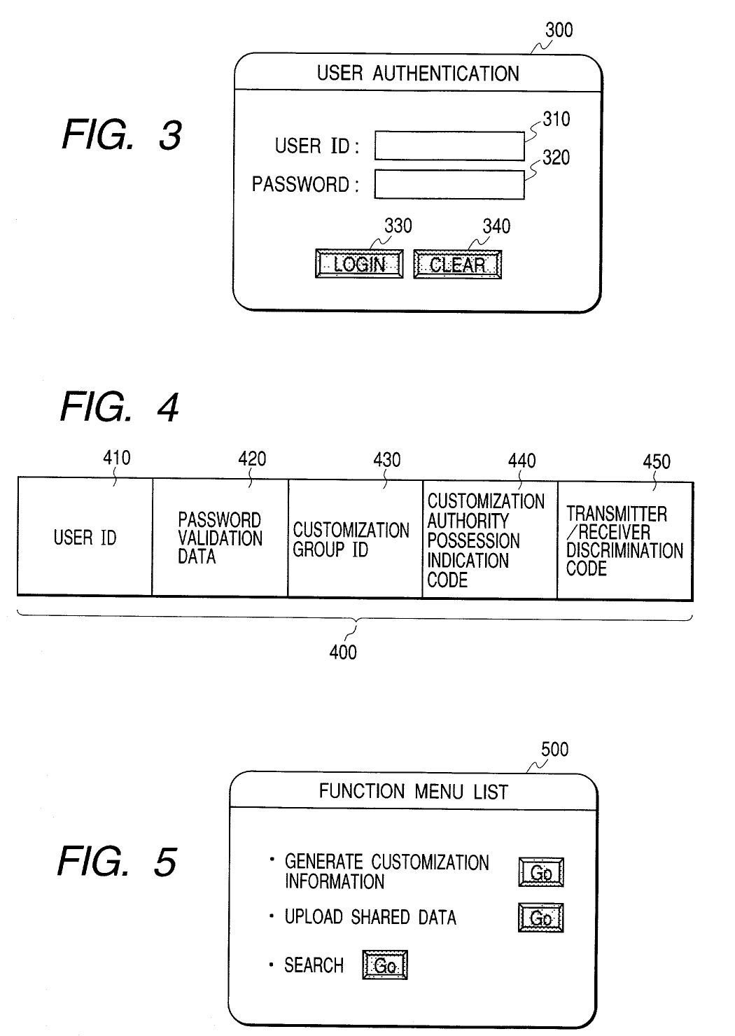

FIG. 3 shows an example of the login screen. As shown in FIG. 3, the login screen includes input fields for receiving information necessary to authenticate the user. Specifically, the screen shown in FIG. 3 includes a user ID input field 310 and a password input field 320.

At step S30, the user enters his or her user ID and password into these input fields and transmits them to the information sharing server 11. At step S120, the information sharing server 11 authenticates the user based on the user ID and password transmitted from the terminal. Specifically, at this authenticating step, the above user ID and password are compared with the user list registered in the user list memory area connected to the information sharing server 11 beforehand to determine whether the login attempt has been made by an authenticated user.

Furthermore, it is determined which customization group the user belongs to and whether the user is an information transmitter or an information viewer.

FIG. 4 is a diagram showing a data structure of the user list. The user list, which is used for the above determination, preferably includes a user ID field 410, a password validation data field 420, a customization group ID field 430, a customization authority possession indication code field 440, and a transmitter/receiver discrimination code field 450.

If it is determined from the above verification that the user is not authenticated (because the user does not satisfy predetermined conditions in the above verification, meaning that the user is an unauthenticated user) at step S130, the processing flow branches to step S110 at which the information sharing server 11 transmits the HTML data file expressing the login screen again.

If it is determined that the user is authenticated, on the other hand, the processing flow proceeds to step S140 at which the information sharing server 11 transmits an HTML file for a menu screen prepared within the file system beforehand while holding information on the user's customization group ID, customization authority possession indication code, and transmitter/receiver discrimination code. At that time, the HTML file for the menu screen to be transmitted differs depending on the information on the customization authority possession indication code and the transmitter/receiver discrimination code. When the information on the transmitter/receiver discrimination code indicates “transmitter” and furthermore the customization authority possession indication code indicates “granted”, the information sharing server 11 transmits an HTML file for a menu screen which includes three alternatives for further processing; namely “generate customization information”, “upload shared data”, and “search”.

FIG. 5 shows an example of the above menu screen. When the information on the transmitter/receiver discrimination code indicates “transmitter” and the customization authority indication code indicates “not granted”, the information sharing server 11 transmits an HTML file for a menu screen which includes “upload shared data” and “search” as alternatives but does not include “generate customization information”. When the information on the transmitter/receiver discrimination code indicates “receiver”, the information sharing server 11 transmits an HTML file for a menu screen which includes “search” as a selection item but does not include “generate customization information” and “upload shared data”.

The terminal receives an HTML file for a menu screen and displays the screen in the browser at step S40. At step S50, the user selects and inputs a desired function from the alternatives displayed on the screen. The browser transmits information on a URL (Uniform Resource Locator) corresponding to the selected function to the “information sharing server 11” side. At step S150, the information sharing server 11 receives the information on the URL corresponding to the selected function from the terminal side, and the processing flow branches to the processing corresponding to each function. It should be noted that a URI (Universal Resource Identifier) may be used instead of a URL.

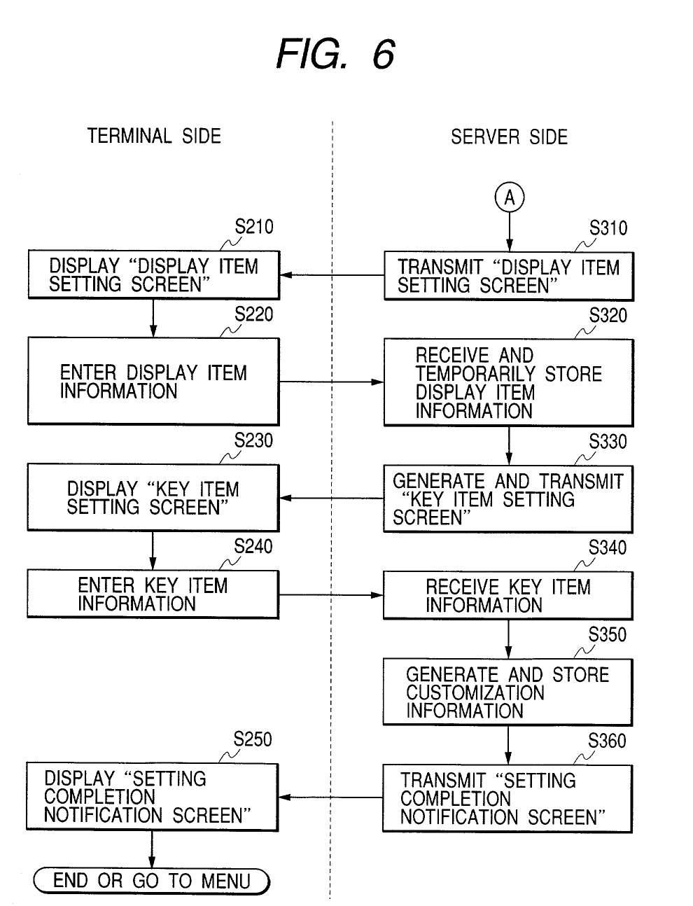

If the function “generate customization information” is selected, the processing flow shown in FIG. 6 is carried out after step S150. First of all, the information sharing server 11 retrieves an HTML file containing a menu screen for setting display items included in the customization information, prepared within the file system beforehand, and transmits the retrieved file to the terminal side at step S310. At step S210, the terminal displays a screen in the browser based on information contained the received HTML file. At step S220, the user makes selections and/or enters character strings on the displayed screen so as to input information on items to be displayed.

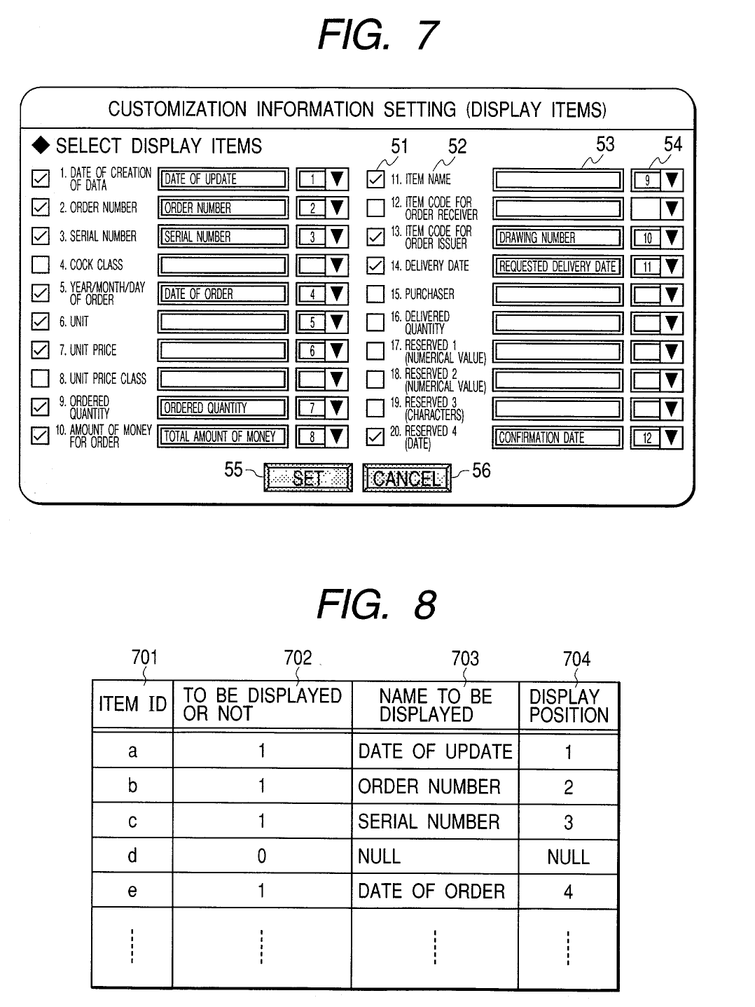

FIG. 7 shows an example of the display item setting screen. FIG. 7 shows a display item setting screen on which the user has already set the display items. The display item setting screen displays the following boxes and fields for each item (20 items in the example of FIG. 7): a check box 51 for setting whether to display this item as search result data after a search is conducted; a default display item name field 52, an input text field 53 for setting a display item name different from the default display item name; and a list box 54 for setting the display order of the item. The user selects (checks) the check box 51 for each item that he or she wants to use, and if the user wants to use a display item name different from the default display item name 52 for the item, the user enters each desired string in the corresponding input text field 53. Furthermore, the user selects the display order of each selected item in the corresponding list box 54. After setting each item as shown in FIG. 7, the user presses a setting button 55 on the screen to transmit the input information to the “information sharing server 11” side. Incidentally, the terminal 31 (information viewer) itself may define customization information on information to be displayed in the terminal 31, or alternatively, the terminal 21 (information transmitter) may define it instead. Similarly, the terminal 21 (information transmitter) itself may define customization information on information to be displayed in the terminal 21, or alternatively, the terminal 31 (information viewer) may define it instead.

FIG. 8 shows the configuration of data to be transmitted. As shown in FIG. 8, the data to be transmitted includes data for an item ID field 701, a “to be displayed or not” field 702, a “name to be displayed” field 703, and a display position field 704 for each (display) item. The data to be transmitted may include other field items. It is assumed that setting the value “1” in the “to be displayed or not” field indicates “to be displayed”, while “0” indicates “not to be displayed”. When “not to be displayed” has been selected, it does not matter whether the “name to be displayed” field and the display position field are set or left blank. FIG. 8 shows a portion of the data to be transmitted when display items are specified as shown in FIG. 7.

At step S320, the information sharing server 11 receives display item setting information, and temporarily stores it. At step S330, the information sharing server 11 generates an HTML file for a key item setting screen based on the display item setting information and transmits it to the terminal side.

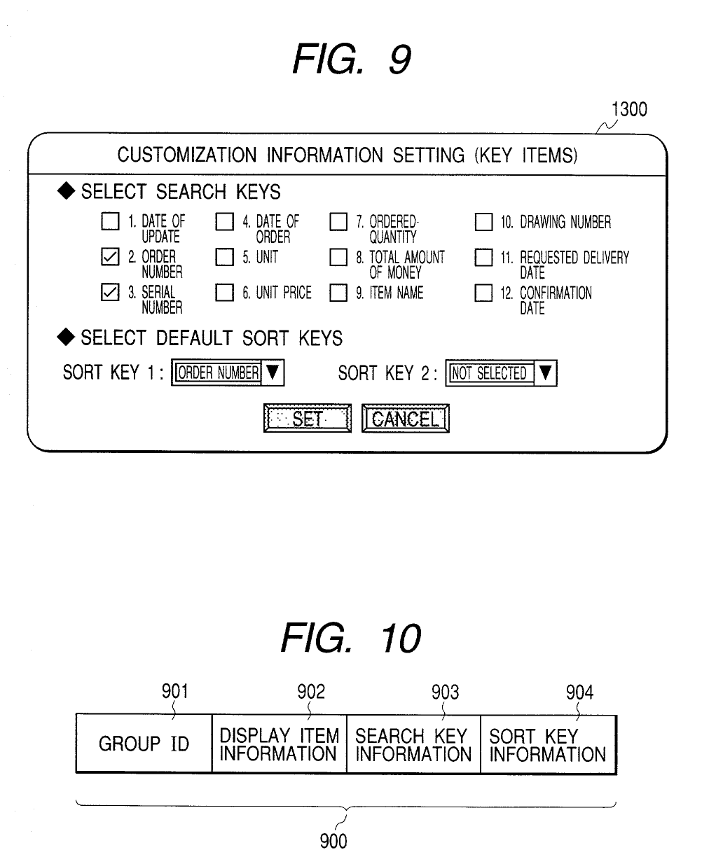

FIG. 9 shows an example of the generated key item setting screen. The key item setting screen includes a portion for setting search key items and a portion for setting the default sort keys (it should be noted that even though FIG. 9 shows a key item setting screen on which some key items have been already set by selecting the corresponding check boxes, the key item setting screen has no items set right after it has been generated). The portion for setting search key items is generated on the screen by extracting items whose “to be displayed or not” field is set to “1” (indicating “to be displayed”) from the display item setting information temporarily held at step S320, and arranging each item's check box and display name in the order indicated by the display position of the item.

At that time, the item ID of each item is given to the check box of the item as its name. Each item ID is not indicated on the screen. That is, the item ID given to each selected check box is sent from the terminal to the server side. The portion for setting the default sort keys, on the other hand, is generated on the screen by extracting items whose “to be displayed or not” field is set to “1” (indicating “to be displayed”) from the display item setting information temporarily stored at step S320, and arranging two same list boxes each listing the display names of all the extracted items and a “Not Selected” as alternatives. At that time, each alternative is given the corresponding item ID as its name. The alternative “Not Selected” is named just “Not Selected”. Each item ID is not indicated on the screen. That is, the item ID corresponding to the display name of each selected alternative is sent from the terminal to the server side.

The terminal receives an HTML file for the key item setting screen and displays it in the browser at step S230. At step S240, the user sets key items and presses the set button to transmit the key item setting information to the information sharing server 11. In the example of FIG. 9, the information to be transmitted is such that “search key =b & c”, “default sort key 1=b”, and “default sort key 2 =Not Selected”.

The information sharing server 11 receives the above key item setting information at step S340. At step S350, the information sharing server 11 puts together and stores the display item setting information temporarily stored at step S320 and the key item setting information received at step S340 as customization information.

FIG. 10 shows the data structure of the customization information. The customization information comprises a group ID field 901, a display item information field 902, a search key information field 903, and a sort key information field 904. With the setting in the above example, the data shown in FIG. 8 is stored as the display item information, and the default data “b & c” and the data “b” are stored as the search key information and the sort key information, respectively.

The information sharing server 11 retrieves an HTML file for a setting completion notification screen prepared within the file system and transmits it to the terminal side at step S360. At step S250, the terminal 21 displays the received setting completion notification screen, which ends the processing (or the processing returns to the menu screen).

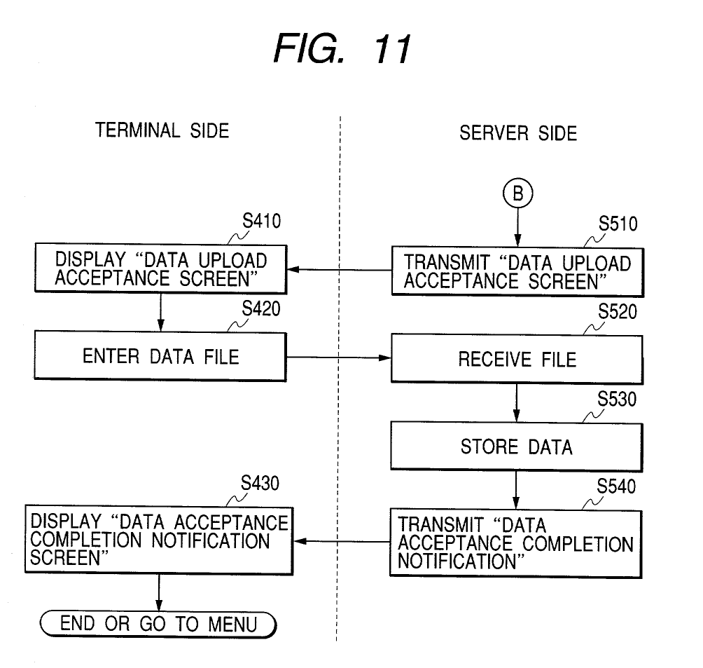

If the function “upload shared data” is selected at step S150 of the main processing flow shown in FIG. 2, the processing flow shown in FIG. 11 is followed. At step S510, the information sharing server 11 transmits an HTML file containing a screen for accepting upload of a shared data file to the terminal 21. At step S410, the terminal 21 receives the HTML file and displays an upload acceptance screen for shared data files based on the contents of the received HTML file.

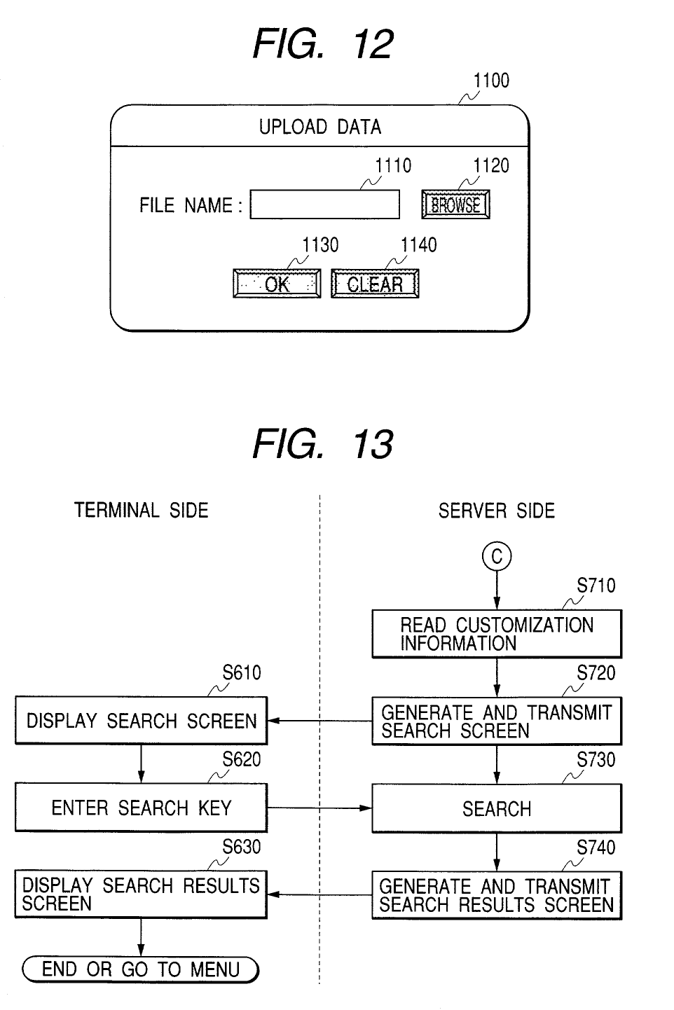

FIG. 12 shows an example of the upload acceptance screen for shared data files. At step S420, the user enters the file name of a shared data file on the acceptance screen, making it possible for the terminal 2 to specify the target data file from which data is to be read. The terminal 2 transmits the read data to the information sharing server 11. At step S520, the information sharing server 11 receives the data transmitted from the terminal 2. The information sharing server 11 stores the received data in the shared data memory area 12 at step 530. After storing all received data, the information sharing server 11 retrieves an HTML file containing a screen for notifying data acceptance completion prepared within the file system beforehand and transmits the file to the terminal 21 at step S540. At step S430, the terminal 21 receives the HTML file and displays the data acceptance completion notification screen. After that, the processing ends (or returns to the menu screen).

If the function “search” is selected at step S150 in FIG. 2, the processing flow shown in FIG. 13 is followed. At step S710, the information sharing server 11 reads customization information from the customization information memory area 14. Specifically, the information sharing server 11 first searches the user list memory area 13 using as a key the user ID authenticated at step S120, and reads the user list data 400 for the target user. The information sharing server 11 then searches the customization information memory area 14 using as a key the value of the customization group ID included in this user list data 400, and reads the customization information 900 set for the target user.

At the next step S720, the information sharing server 11 generates a search screen page file and transmits it to the terminal 2. Specifically, the search screen page file is generated as follows. Assume that the data in the above customization information setting example is set as the customization information 900. The information sharing server 11 first reads the search key information 903 from the customization information 900, and since the search key information 903 is the data “b & c”, the information sharing server 11 determines that an input field named “b” and an input field named “c” are required.

The information sharing server 11 then reads the display item information 902, and since data as shown in FIG. 8 is set (as the display item information 902), the information sharing server 11 determines that the display item name for the input field “b” is “order number”, and the display item name for the input field “c” is “serial number”. Based on the above two determinations, the information sharing server 11 generates an HTML file for a screen having the following components arranged thereon: text for prompting for user operation; the character string “order number”; the input field “b”; the character string “serial number”; the input field “c”; a button for starting a search; and a button for clearing input values. At step S610, the terminal side receives the HTML file and displays the search screen.

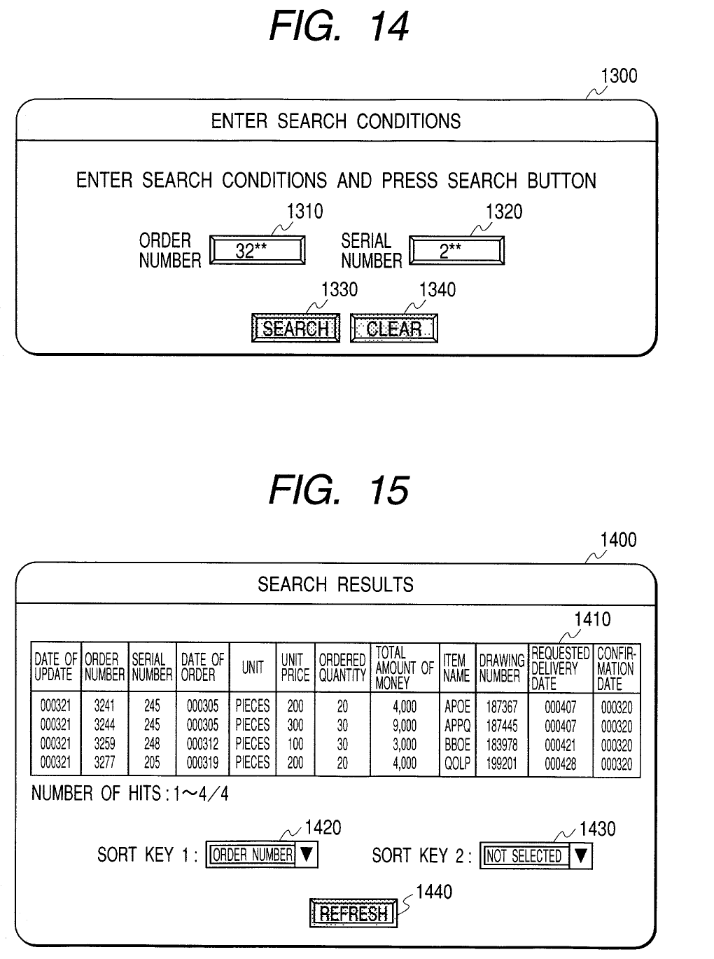

FIG. 14 shows an example of the search screen. At step S620, the user enters search conditions on the search screen. FIG. 14 shows a search screen on which search conditions have been already input in input fields 1310 and 1320. In this example, the symbol “*” denotes any character (a single digit). That is, the input search conditions shown in FIG. 14 indicate a search for data whose order number and serial number are on the order of 3200 and 200, respectively. It should be noted, however, that this search conditions input rule is just an example for implementing the present invention. Another search conditions input rule may be used instead. When the user has pressed a search button 1330, the terminal transmits the search conditions to the information sharing server 11. The search conditions data to be transmitted is “b=32** & c=2**”. That is, the search conditions data is made up of a plurality of pairs of the item ID given to an input field and an value entered into the input field put together serially.

At step S730, the information sharing server 11 performs a search based on the search conditions data transmitted from the terminal. At that time, how to display the search results is determined based on the customization information 900. With the above search conditions provided, the information sharing server 11 searches for any data whose item ID “b” is set to “32**” (that is, any values whose upper two figures are “32”) and whose item ID “c” is set to “2**” (that is, any values whose uppermost figure is “2”).

With the display item information 902 set as shown in FIG. 8, the information sharing server 11 displays items which are included in the matching data in the search and whose “to be displayed or not” field is set to “1”, namely the item data for the item IDs “a”, “b”, “c”, “e”, . . . , and so on, in the order specified by each display position, that is, in the order of “a”, “b”, “c”, “e”, . . . , and so on. Furthermore, the data (data for each item) is sorted using as a key(s) the item(s) indicated by the item ID(s) (in this example, only the item ID “b”) specified by the sort key information 904.

At step S740, the information sharing server 11 generates an HTML file for a screen containing the search results, and transmits it to the terminal side. Specifically, the information sharing server 11 generates a page file expressing a screen having arranged thereon the following components: on the first line, display names set in the display item information 902 and displayed in the order specified by each display position starting from the left; and, on the second and subsequent lines, a table listing the above search results, list boxes each for selecting a sort key, and a button for instructing that a search be carried out again and the search results be displayed. At step S630, the terminal receives the HTML file and displays the search results screen. FIG. 15 shows an example of the search results screen to be displayed.

It should be noted that each notification may be made by electronic mail instead of an HTML file.

According to the present embodiment, when a third party (service site 10) provides mediation service for information sharing between any information transmitter (information transmitter site 20) and information viewer (information viewer site 30), the third party can efficiently use the memory are of its database without producing any redundancy. Furthermore, the information transmitter which uses the mediation service can freely set data item names for information to be shared with the information viewer and the display order of the data items, indicating the information to the information viewer as intended.

What is claimed is:

1. An information indicating method employing an information sharing apparatus coupled with an information transferring apparatus for transferring information and an information viewing apparatus for viewing said information through a network; said information indicating method comprising the steps of:
storing both an identifier for identifying said transmitting apparatus and customization information for determining an indication form of said information, in such a way that said identifier and said customization information are associated with each other;
receiving said information and said identifier from said information transmitting apparatus;
storing said received information in storage units corresponding to each said identifier;
receiving from said information viewing apparatus a request for viewing partial information included in said stored information;
searching for customization information corresponding to an identifier of said partial information; and
indicating on said information viewing apparatus said partial information in an indication form determined based on said customization information retrieved as a result of said search.

2. The information indicating method as claimed in claim 1, wherein said identifier and said customization information are received from said information transmitting apparatus before said identifier and said customization information are stored in such a way that said identifier and said customization information are associated with each other.

3. The information indicating method as claimed in claim 1, wherein an item name of an item included in said partial information is indicated in such a way that said item name is changed for each said identifier.

4. The information indicating method as claimed in claim 1, wherein an item order of an item constituting said partial information is indicated in such a way that said item order is sorted (changed) for each said identifier.

5. An information indicating apparatus for indicating information based on a request, said apparatus comprising:
storing means for storing information in predetermined storage units, said information being able to be indicated;
memory means for storing each said storage unit in such a way that customization information is associated with each said storage unit, said customization information having its indication manner defined;
accepting means for accepting a request for indicating partial information included in said information; and
indicating means for indicating said partial information in an indication manner defined by customization information corresponding to storage units constituting said partial information.

6. The information indicating apparatus as claimed in claim 5, wherein said customization information includes an indication form of said partial information.

7. The information indicating apparatus as claimed in claim 5, further comprising:
receiving means for, from an information transmitting apparatus which transmits said information, receiving said information and an identifier for identifying a manager of said information transmitting apparatus;
wherein said storing means stores said information in said storage units corresponding to each said identifier, and said memory means stores each said identifier in such a way that said customization information is associated with each said identifier.

8. The information indicating apparatus as claimed in claim 7, further comprising:
another receiving means for receiving a request for viewing said identifier and said partial information from an information viewing apparatus capable of viewing said partial information.

9. The information indicating apparatus as claimed in claim 5, wherein said customization information includes a predefined indication item and a customization indication item name defined by a person who needs to indicate said partial information, in such a way that said predefined indication item and said customization indication item name are associated with each other; and said indicating means indicates said partial information expressed by use of said customization indication item name.

10. The information indicating apparatus as claimed in claim 9, further comprising:
transmitting means for, to said person who needs to indicate said partial information, transmitting data for prompting for input of said customization indication item name for said indication item; and
receiving from said person who needs to indicate said partial information said customization indication item name entered for said indication item.

11. A program for causing a computer to perform predetermined processing, said predetermined processing comprising:
an input step of receiving both an identifier for identifying a provider of information to be stored in a storage apparatus and said information;
a holding step of storing said identifier and customization information for specifying an indication form of said information in such a way that said identifier and said customization information are associated with each other;
a storing step of storing said information provided by said provider in storage units corresponding to said identifier;
a receiving step of receiving a request for viewing partial information included in said information;
a searching step of searching for customization information corresponding to an identifier of said partial information; and
an indicating step of indicating said partial information in an indication manner corresponding to said customization information.

12. An information indicating method for indicating information after customizing said information, said method comprising the steps of:
receiving through a network said information from an information transmitting apparatus which transmits said information;
converting an item name included in said information into a customization item name defined by an information viewing apparatus capable of viewing said information; and
transmitting said information expressed by use of said customization item name to said information viewing apparatus.

13. The information indicating method as claimed in claim 12, further comprising steps of:
storing a corresponding relationship between said item name included in said information and said customization item name beforehand; and
converting said item name included in said information into said customization item name based on said corresponding relationship.

14. The information indicating method as claimed in claim 12, further comprising steps of:
generating said partial information based on items selected by said information viewing apparatus from among items included in said information; and
transmitting said partial information to said information viewing apparatus through a network.
